(19) United States
(12) Patent Application Publication
(10) Pub. No.: US 2015/0375986 A1
(43) Pub. Date: Dec. 31, 2015

(54) Rod Valve

(71) Applicant: GSSC, Inc., Clearwater, FL (US)

(72) Inventors: Blake K. Travis, II, Clearwater, FL (US); Tom Hedger, Trinity, FL (US)

(73) Assignee: GSSC, INC., Clearwater, FL (US)

(21) Appl. No.: 14/316,862

(22) Filed: Jun. 27, 2014

(51) Int. Cl. B67D 7/74; B05C 11/10

(52) U.S. Cl. CPC B67D 7/74; B05C 11/1036

(57) ABSTRACT

A dispensing system has a head assembly affixed to a mixing chamber. The head assembly is fluidly interfaced to a first rod seat and the second rod seat. The first rod has a first rod head and the second rod has a second rod head. Distal ends of both rods are interfaced to a system for moving. In a closed position, the first rod head seats in the first rod seat and the second rod head is seated in the second rod seat, blocking fluid communication between the first input port and the mixing chamber and between the second input port and the mixing chamber. In an open position, the first rod head is separated from the first rod seat and the second rod head is separated from the second rod placing the first input port and the second input port in fluid communication with the mixing chamber.

### FIELD

This invention relates to the field of valves and more particularly to a rod valve system for controlling a flow of one or more fluids.

### BACKGROUND

It is often required to control the flow of one or more fluids in applications of dispensing fluids on a surface such as spraying/dispensing adhesives on a surface that is to be bonded to another surface, or spraying/dispensing materials on a surface to coat the surface or to coat a mold in the process of making a molded product/part.

Often high viscosity materials are emitted from such an apparatus (e.g. a dispensing gun). Often, such materials are also highly abrasive. Past valve systems often used ball valves, in which a ball having an orifice through a center of the ball is rotated within a seat to either block the flow of the fluid (when the orifice is within the seat) or to allow flow of the fluid (when the orifice is aligned with the direction of flow of the fluid). Ball valves work for some fluids, but are not reliable for abrasive materials. To improve the reliability of ball valves, some ball valve ball portions are coated with ceramic, but it is difficult and expensive to properly coat the ball portion of the ball valve with ceramic.

What is needed is a valve system that will replace other available valves in applications in which high viscosity, abrasive fluids are being controlled.

### SUMMARY

In one embodiment, a dispensing apparatus is disclosed including a first input port in a head assembly, the first input port fluidly interfaced to a source of a first fluid material, the first fluid material being pressurized, the head assembly having a first rod seat, the first rod seat fluidly interfaced to a mixing chamber. A first end of a first rod has a first rod head and a distal second end of the first rod is interfaced to a system for moving the first rod in a linear movement. The first rod is moved between a closed position in which the first rod head is seated in the first rod seat and an open position in which the first rod head is separated from the first rod seat. The first fluid material flows from the first input port, through the first rod seat, and into the mixing chamber when the first rod is moved out of the closed position by the system for moving and the first fluid material is blocked from flowing from the first input port into the mixing chamber when the first rod is moved to the closed position by the system for moving.

In another embodiment, a dispensing system is disclosed including a head assembly that has a first input port, a second input port, a first rod seat, and a second rod seat. A mixing chamber is affixed to a first side of the head assembly and is fluidly interfaced to both the first rod seat and the second rod seat. A first end of a first rod has a first rod head and a distal second end of the first rod interfaced to a system for moving (e.g., a rack/pinion gear interfaced to a valve operation handle). A first end of a second rod has a second rod head and a distal second end of the second rod is also interfaced to the system for moving. The first rod is synchronously moved with the second rod by the system for moving, such that in a closed position, the first rod head is seated in the first rod seat and the second rod head is seated in the second rod seat, and in an open position, the first rod head is separated from the first rod seat and the second rod head is separated from the second rod seat. In the open position, the first input port is in fluid communication with the mixing chamber through the first rod seat and the second input port is in fluid communication with the mixing chamber through the second rod seat, and in the closed position, the first rod head blocks fluid communication between the first input port and the mixing chamber and the second rod head blocks fluid communication between the second input port and the mixing chamber.

In another embodiment, a dispensing system is disclosed including a head assembly that has a first input port, a second input port, a first rod seat, and a second rod seat. A mixing chamber is affixed to a first end of the head assembly and is fluidly interfaced to both the first rod seat and the second rod seat. A first end of a first rod has a first rod head and a distal second end of the first rod is interfaced to a block that is movably held within a trigger frame. The block has a rack gear that interfaces to a round gear which is rotatably held by the trigger frame. The trigger frame is bolted to an opposing second end of the head assembly. A first end of a second rod has a second rod head. A distal second end of the second rod interfaced to the block. The first rod is synchronously moved with the second rod by the block, such that in a closed position, the first rod head is seated in the first rod seat and the second rod head is seated in the second rod seat. In an open position, the first rod head is separated from the first rod seat and the second rod head is separated from the second rod seat. In the open position, the first input port is in fluid communication with the mixing chamber through the first rod seat and the second input port is in fluid communication with the mixing chamber through the second rod seat, and in the closed position, the first rod head blocks fluid communication between the first input port and the mixing chamber and the second rod head blocks fluid communication between the second input port and the mixing chamber.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a dispensing gun example having a rod valve.

FIG. 2 illustrates an exploded view of the dispensing gun example having the rod valve.

FIG. 3 illustrates a cut-away plan view of the dispensing gun example having the rod valve from a first side.

FIG. 4 illustrates a cut-away plan view of the dispensing gun example having the rod valve from a second side.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Although described for use with highly viscous, abrasive fluids, there is no restriction on what types of fluids are controlled by the disclosed rod valve and dispensing apparatus, as in the dual rod valve example shown. It is anticipated that one or both fluids being controlled are high viscosity, highly abrasive fluids and, one or both of the fluids being controlled are not high viscosity or highly abrasive. It is also anticipated that, in some embodiments, any number of fluids are controlled by the rod valve as disclosed, including one fluid, two fluids, three fluids, etc.

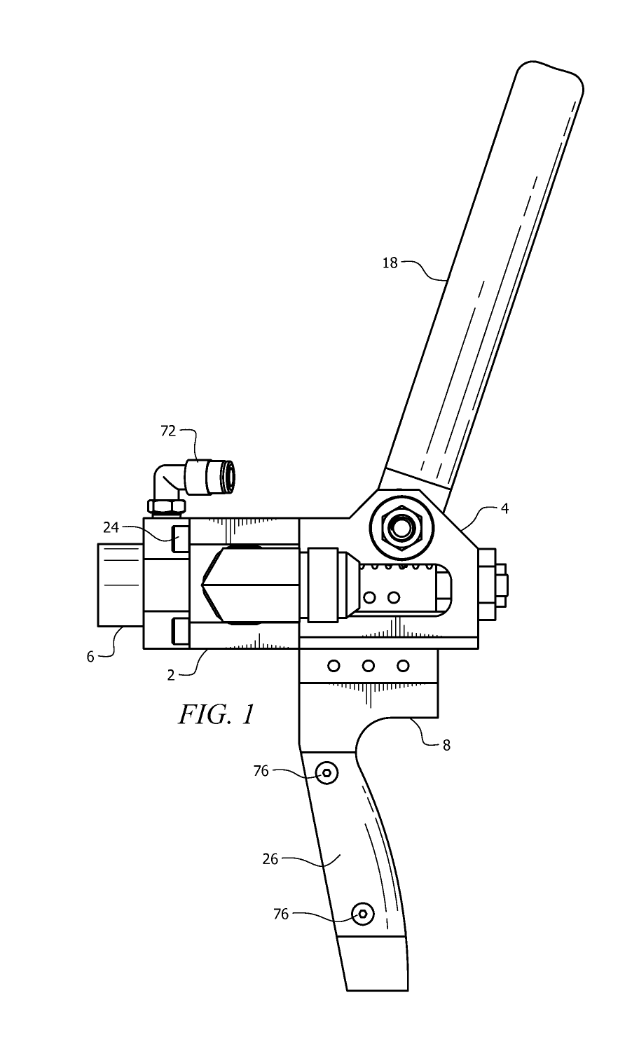

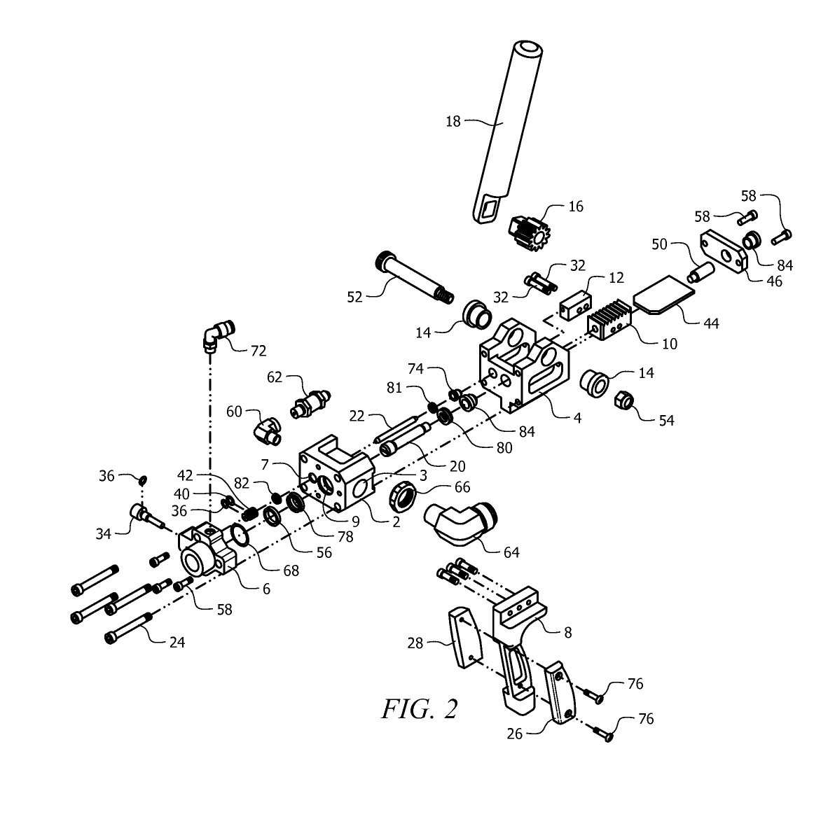

Referring to FIG. 1 illustrates a schematic view of a dispensing device example having a rod valve. The dispensing device shown has handle covers 26/28 held to a handle/base portion 8 with fasteners 76. The handle portion 8 supports a trigger frame 4. A head 2 is bolted onto the trigger frame 4 by one or more fasteners 24. A valve operation handle 18 is rotatably interfaced to the trigger frame 4 and interfaces with a gear 16 (see FIG. 2) that operates the valve. An optional compressed air or solvent input 72 provides pressurized air and/or a solvent to a mixing manifold 6, typically after operation to flush the dispensing gun and any mixer/nozzle mounted to the front of the mixing chamber 6.

In operation, the valves are closed (no fluid flow) when the valve operation handle 18 is in the position shown. Pushing the valve operation handle 18 towards the mixing manifold 6 initiates a flow of the fluids.

FIG. 2 illustrates an exploded view of the dispensing device example having the rod valve. Although any number of rod valves is anticipated for inclusion in a device such as the dispensing device shown in the example, two synchronized rod valves are shown with rods 22 and 20. Although any size of rod valves is anticipated for inclusion in a device such as the dispensing device shown in the example, one larger rod valve with rod 20 and one smaller rod valve with rods 22 is shown.

Linear movement of the rod(s) 20/22 is performed by movement of block(s) 10/12 that are affixed to each other by one or more fasteners 32. Although it is anticipated that any mechanism be used to move the block(s) such as a compressed air or hydraulic cylinder, in the example shown, a first block 10 has a rack gear on an upper surface that links to a round gear 16. The round gear 16 turns when the valve operation handle 18 is pushed forward/backward. The valve operation handle 18 and round gear 16 are rotatably coupled to the trigger frame 4 by a fasteners/axle 52/54 and, optionally bearings 14. In some embodiments, to reduce slippage, the round gear 16 is interface to the valve operation handle 18 by a non-round coupling as, for example, the square coupling that is shown. For completeness, a back cover 46 and bottom plate 44 are held to the trigger frame by fasteners 58.

In some embodiments, a guide rod 50 is affixed to one of the blocks 10/12. The guide rod passes through a bushing 84 on the back plate 46 to keep the block(s) 10/12 in alignment with the rods 20/22 and round gear 16.

In some embodiments, a bearing 84 guides one of the rods 20 into the trigger frame 4 and, likewise in embodiments having a guide rod 50, the bearing 84 also guides the guide rod 50 into the back plate 46. In some embodiments, a second bearing 74 guides a second rod 22 into the trigger frame 4. Although any typical bearing material is anticipated, in a preferred embodiment, the bearings 84/74 are made from Polyoxymethylene (POM), also known as acetal, polyacetal and polyformaldehyde. In this example, rod seals 80/82 reduce leakage back into the trigger frame 4.

Seals 78/80/82 are held in the head 2 by seal retainers 42/56 and o-rings 68/36/40, reducing leakage between the head 2 and the mixing chamber 6 and between the head 2 and the trigger frame 4.

Fluids enter the head 2 through couplings 60/64/66, shown as elbow couplings 60/64, though there is no restriction on the shape or size of the couplings 60/64. In a typical use, the catalyzer, under pressure, is provided to the catalyzer coupling 60 and the base material (e.g. resin, adhesive, putty, etc.) is provided, under pressure, to the material coupling 64. In preferred embodiments, there is a check valve 62 coupled to the catalyzer coupling 60 to prevent catalyzer/material from back flowing into a catalyzer input line, especially when the base material source is at a higher pressure than the catalyzer source.

The mixing chamber 6 is held to the head 2 by a set of fasteners 58 and the head 2 is held to the trigger frame by another set of fasteners 24. The air/solvent input 72 is shown fluidly connected to the mixing chamber 6. The exemplary dispensing device has handle covers 26/28 held to the handle/base portion 8 with fasteners 76. The handle portion 8 supports a trigger frame 4.

When the rods 20/22 are force forward (e.g. valve operation handle 18 is pulled back), the forward ends (closest to the mixing chamber 6) butt against the seals in the head 2, preventing flow. In this example, the larger rod 20 prevents flow of the material from the material coupling 64 and the smaller rod 22 prevents flow of the catalyzer from the catalyzer coupling 60. As the rods 20/22 are pulled back (e.g. as the valve operation handle is pushed forward towards the mixing chamber 6), catalyzer flows around the end of the smaller rod 22, through a smaller orifice 7 in the head 2 and into the mixing chamber 6. Likewise, material (e.g. resin) flows around the end of the larger rod 20, through a larger orifice 9 in the head 2 and into the mixing chamber 6 where both the catalyzer and the resin are mixed.

For some catalyzer/material, a mixing device is inserted into the mixing chamber 6. It is anticipated that a nozzle (not shown) is removably affixed to the front of the mixing chamber 6 for the desired application cone/shape.

Some embodiments include a catalyzer restrictor 34 with a catalyzer restrictor o-ring 36 for further control of the mixture of catalyzer to the fluid material.

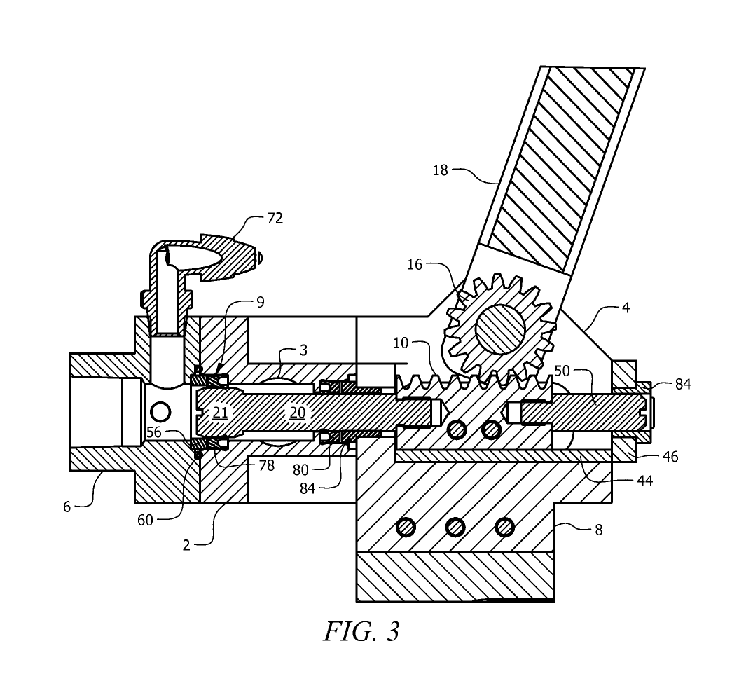

FIG. 3, a cut-away plan view of the dispensing gun example having the rod valve from a first side is shown. In this view, the larger rod 20 is engaged with the seal 78, preventing flow of the material (e.g. resin) from the material input port 3 (which is provided under pressure to the material input port 3 through the material input coupling 64). Material under pressure enters the material input port 3 and pressure from the block 10 and from the material asserted against the back of the larger rod head 21 prevents flow of the material to the mixing chamber 6. When the handle 18 is pushed toward the mixing chamber 6, the block 10 is pulled in a direction away from the mixing chamber 6 and, consequently, the larger rod head 21 is pulled out of the seat 78, thereby allowing flow of the material from the material input port 3 through the larger orifice 9 in the head 2 toward the mixing chamber 6.

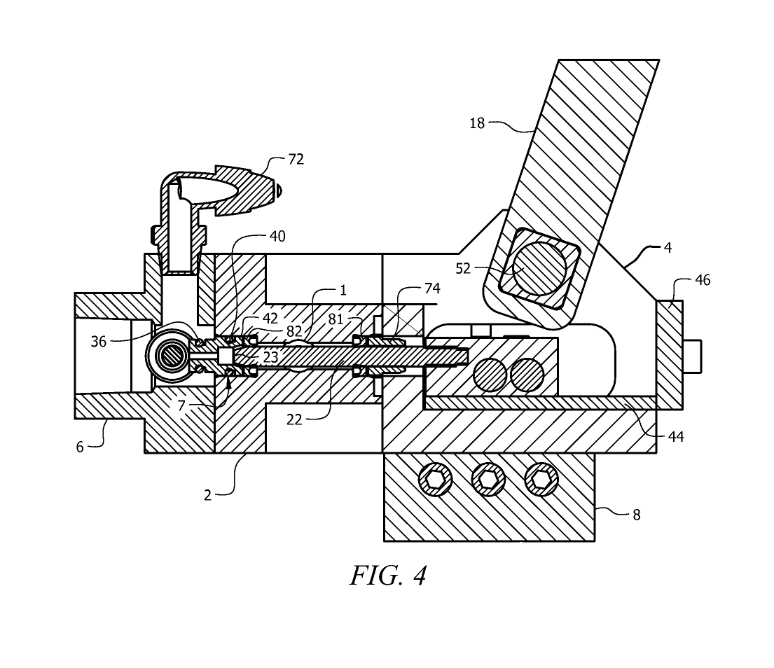

FIG. 4, a cut-away plan view of the dispensing gun example having the rod valve from a second side is shown. In this view, the smaller rod 22 is engaged with the seal 82, preventing flow of the catalyzer from the catalyzer input port 1 (which is provided under pressure to the catalyzer input port 3 through the catalyzer input coupling 60). Catalyzer, under pressure, enters the catalyzer input port 1 and pressure from the block 12 prevents flow of the catalyzer to the mixing chamber 6. When the handle 18 is pushed toward the mixing chamber 6, the block 12 is pulled in a direction away from the mixing chamber 6 and, consequently, the smaller rod head 23 is pulled out of the seat 82, thereby allowing flow of the material from the material input port 1 through the smaller orifice 7 in the head 2 toward the mixing chamber 6.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A dispensing apparatus comprising:
a first input port in a head assembly, the first input port fluidly interfaced to a source of a first fluid material, the first fluid material being pressurized, the head assembly having a first rod seat, the first rod seat fluidly interfaced to a mixing chamber;
a first rod, a first end of the first rod having a first rod head and a distal second end of the first rod interfaced to means for moving the first rod in a linear movement;
whereas, the first rod is moved between a closed position in which the first rod head is seated in the first rod seat and an open position in which the first rod head is separated from the first rod seat, whereas the first fluid material flows from the first input port, through the first rod seat, and into the mixing chamber when the first rod is moved out of the closed position.

2. The dispensing apparatus of claim 1, wherein the means for moving the first rod comprises a block with a rack gear, the block interfaced to the distal end of the rod, a round gear interfaced to the rack gear such that rotation of the round gear moves the rack gear and hence the block and the first rod in the linear movement.

3. The dispensing apparatus of claim 1, wherein the round gear is interfaced to a valve operation handle.

4. The dispensing apparatus of claim 1, further comprising:
a second input port in the head assembly, the second input port fluidly interfaced to a source of a fluid catalyst, the fluid catalyst being pressurized, the head assembly having a second rod seat, the second rod seat fluidly interfaced to the mixing chamber;
a second rod, a first end of the second rod having a second rod head and a distal second end of the second rod interfaced to means for moving the first rod in a linear movement;
whereas, the second rod is moved between a second rod closed position in which the second rod head is seated in the second rod seat and a second rod open position in which the second rod head is separated from the second rod seat, whereas the fluid catalyst flows from the second input port, through the second rod seat, and into the mixing chamber when the second rod is moved out of the second rod closed position.

5. The dispensing apparatus of claim 4, wherein the first fluid material and the fluid catalyst mix in the mixing chamber when the first rod is moved out of the first rod closed position and the second rod is moved out of the second rod closed position.

6. The dispensing apparatus of claim 4, wherein the first fluid material is a resin.

7. The dispensing apparatus of claim 4, wherein the first fluid material is an adhesive.

8. The dispensing apparatus of claim 4, wherein the first fluid material is a putty.

9. A dispensing system comprising:
a head assembly having a first input port, a second input port, a first rod seat, and a second rod seat;
a mixing chamber fluidly interfaced to both the first rod seat and the second rod seat, the mixing chamber affixed to a first side of the head assembly;
a first end of a first rod having a first rod head and a distal second end of the first rod interfaced to a means for moving;
a first end of a second rod having a second rod head and a distal second end of the second rod interfaced to the means for moving;
whereas, the first rod is synchronously moved with the second rod by the means for moving, such that in a closed position, the first rod head is seated in the first rod seat and the second rod head is seated in the second rod seat, and in an open position, the first rod head is separated from the first rod seat and the second rod head is separated from the second rod seat, whereas in the open position, the first input port is in fluid communication with the mixing chamber through the first rod seat and the second input port is in fluid communication with the mixing chamber through the second rod seat, and in the closed position, the first rod head blocks fluid communication between the first input port and the mixing chamber and the second rod head blocks fluid communication between the second input port and the mixing chamber.

10. The dispensing apparatus of claim 9, wherein the means for moving comprises a block with a rack gear, the block interfaced to the distal end of the first rod and to the distal end of the second rod, a round gear interfaced to the rack gear such that rotation of the round gear moves the rack gear and hence the block and therefore the first rod and the second rod.

11. The dispensing apparatus of claim 10, wherein the round gear is interfaced to a valve operation handle.

12. The dispensing apparatus of claim 9, wherein the first fluid material and the fluid catalyst mix in the mixing chamber when the first rod is moved out of the first rod closed position and the second rod is moved out of the second rod closed position.

13. The dispensing apparatus of claim 12, wherein the first fluid material is a resin.

14. The dispensing apparatus of claim 12, wherein the first fluid material is an adhesive.

15. The dispensing apparatus of claim 12, wherein the first fluid material is putty.

16. A dispensing system comprising:
a head assembly having a first input port, a second input port, a first rod seat, and a second rod seat;
a mixing chamber fluidly interfaced to both the first rod seat and the second rod seat, the mixing chamber affixed to a first end of the head assembly;
a first end of a first rod having a first rod head and a distal second end of the first rod interfaced to a block, the block movably held within a trigger frame, the block having a rack gear, the rack gear interface to a round gear, the round gear rotatably held by the trigger frame, the trigger frame interfaced to an opposing second end of the head assembly;
a first end of a second rod having a second rod head and a distal second end of the second rod interfaced to the block;
whereas, the first rod is synchronously moved with the second rod by the block, such that in a closed position, the first rod head is seated in the first rod seat and the second rod head is seated in the second rod seat, and in an open position, the first rod head is separated from the first rod seat and the second rod head is separated from the second rod seat, whereas in the open position, the first input port is in fluid communication with the mixing chamber through the first rod seat and the second input port is in fluid communication with the mixing chamber through the second rod seat, and in the closed position, the first rod head blocks fluid communication between the first input port and the mixing chamber and the second rod head blocks fluid communication between the second input port and the mixing chamber.

17. The dispensing apparatus of claim 16, wherein the round gear is interfaced to a valve operation handle.

18. The dispensing apparatus of claim 16, wherein the first fluid material and the fluid catalyst mix in the mixing chamber when the first rod is moved out of the first rod closed position and the second rod is moved out of the second rod closed position.

19. The dispensing apparatus of claim 12, wherein the first fluid material is a resin.

20. The dispensing apparatus of claim 12, wherein the first fluid material is an adhesive.
